(19) United States
(12) Patent Application Publication
(10) Pub. No.: US 2025/0253663 A1
(43) Pub. Date: Aug. 7, 2025

(54) SYSTEM AND METHOD OF BESS CONTROL FOR BULK POWER SYSTEM MONITORING AND CONTROL

(71) Applicant: AES US Services, LLC, Indianapolis, IN (US)

(72) Inventors: Rajarshi Roychowdhury, Centerville, OH (US); Ryan Dolan, Columbus, OH (US); Xuan Wu, Carmel, IN (US); Michael Russ, Tipp City, OH (US)

(73) Assignee: AES US Services, LLC, Indianapolis, IN (US)

(21) Appl. No.: 18/432,262

(22) Filed: Feb. 5, 2024

Related U.S. Application Data
(60) Provisional application No. 63/443,165, filed on Feb. 3, 2023.

(51) Int. Cl. H02J 3/32; H02J 3/00; H02J 7/00

(52) U.S. Cl. CPC H02J 3/32; H02J 3/001; H02J 7/005; H02J 2203/10; H02J 2203/20

(57) ABSTRACT

A method and system for controlling a power grid using a power grid control system is disclosed. The power grid control system may control one or more supplemental power sources, such as by using Battery Energy Storage Systems (BESS). In its control, the power grid control system may control the grid both to operate the power grid within predefined standards and to consider the state of health (SOH) of the BESS. In this way, the power grid control system may enable stable operation of the power grid while also improving the useful life of the BESS.

### REFERENCE TO RELATED APPLICATION

The present application claims priority to U.S. Provisional Application Ser. No. 63/443,165 (filed on Feb. 3, 2023), which is incorporated by reference herein in its entirety.

### FIELD OF THE INVENTION

The present application relates generally to the field of control of a grid. Specifically, the disclosure relates to controlling a grid using one or more Battery Energy Storage Systems (BESS).

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Managing a power transmission grid (interchangeably termed a power grid or grid) typically focuses on providing reliable and stable power in the grid. However, this may be difficult, particularly when parts of the grid may be temporarily unavailable to provide power. One solution to maintain the reliability of the grid is to supplement the grid with one or more power sources, such as one or more BESS. In this way, the BESS may supply the power needed to maintain grid reliability in the event of temporary faults in the grid.

### SUMMARY

In one or some embodiments, a power grid control system configured to control part or all of a power grid is disclosed. The power grid control system comprises: a communication interface configured to receive one or more indicators of status of the power grid and to send one or more commands indicative of control of the part or all of the power grid and at least one central control system (CCS) comprising in communication with the communication interface. The CCS is configured to: automatically access the one or more indicators of the status of the power grid; automatically determine, using the one or more indicators of the status of the power grid, the one or more commands indicative of control of the part or all of the power grid, wherein the determination of the one or more commands is based on both controlling the part or all of the power grid to be within predefined parameters and to factor state of health (SOH) of one or more battery assets supplying power to or receiving power from the part or all of the power grid; and automatically transmit the one or more commands in order to control the part or all of the power grid.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIGS. 1A-C is example block diagrams illustrating high-level system architectures for the system of intelligent BESS control for bulk power system monitoring and control.

FIG. 2A is an example block diagram for the Central Control System (CCS).

FIG. 2B is an example block diagram for the Energy Management System (EMS).

FIG. 3 is another example block diagram for the system of intelligent BESS control for bulk power system monitoring and control.

FIG. 4 is an example flow diagram of the multi-tier control.

FIG. 5 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, a battery asset may be used to supplement power in a grid. Various manifestations of the battery asset are contemplated, such as a BESS. In particular, a BESS with a smart inverter that mimics a STATCOM may be used in combination with digital intelligent control to achieve wide-area monitoring and control of the grid. In one or some embodiments, the intelligent control may comprise compliance with one or more standards (e.g., any one, any combination, or all of: voltage; current; or frequency) for a part of the grid (e.g., a power grid, a microgrid, etc.). The one or more standards may be determined in one of several ways, such as dictated by a regulatory body (e.g., NERC), agreed to by transmission owners, standards organizations, or the like.

For example, NERC requires transmission operators to ensure reliable delivery of electricity even under specific contingency scenarios (e.g., N−1, N−1−1, etc.), such as in the event of a failure of a transmission line, adjacent lines are required to be able to continue to serve load while operating safely (e.g., remaining within voltage and/or thermal limits). In this regard, FERC may establish standards as to voltage, current, and/or frequency at a point of interconnection (POI) in the grid. As one example, FERC may establish that a generating resource (such as a battery asset) operates within a range of 0.95 to 1.05 power units in order to either absorb or inject reactive power so that the voltage on a designated part of the grid (e.g., a bus in a substation) is maintained within the designated range. Other ranges are contemplated (e.g., 0.9 to 1.05, etc.). Further, other definitions of the range are also contemplated (e.g., ranges defined by voltage bands, power factors, or the like). Regardless, an operating range may be defined, which may be used by at least one Central Control System (CCS), discussed below, such as a single CCS, in order to issue commands at a central and/or global level to command battery assets.

However, the battery asset, such as a BESS system, may itself be a valuable asset. Typically, the battery asset is purchased with a standard warranty (e.g., 25 years). Further, the battery assets can cost millions of dollars. In this regard, the intelligent control is configured to extend the lifespan of the battery asset, resulting in potentially great benefit. As such, in one or some embodiments, the intelligent control is configured to perform both of the following: (i) automatically control the grid in compliance with one or more predefined parameters, such as in compliance with the one or more standards (e.g., any one, any combination, or all of: voltage and/or power stability of the grid within predetermined tolerances; remaining within predefined voltage limits; or remaining within predefined thermal limits); and (ii) automatically control in order to consider, take into account, or factor one or more aspects of BESS (e.g., control that considers or accounts for the battery state of health (SOH), such as automatically generating and implementing a control recommendation that is globally optimized for better or improved SOH degradation). As discussed in more detail below, the battery SOH may be impacted by how the battery assets are operated (e.g., any one, any combination, or all of: the initial state of charge (SOC) of the battery assets; the final SOC; the rate at which the battery assets are used; the frequency at which the battery assets are used; etc.). Thus, the intelligent automatic control may perform both the necessary control of the grid to comply with the one or more standards and improve (or optimize) the battery SOH, thereby assisting in reducing or minimizing the amortized battery replacement cost.

In one or some embodiments, the intelligent control may comprise computer-based learning in order to automatically control part or all of a grid. In a first embodiment, the computer-based learning may comprise reinforcement learning. In a second embodiment, the computer-based learning may comprise machine learning. In either embodiment, the computer-based learning may perform both of the following in an interdependent manner: (i) control the grid in compliance with the one or more standards; and (ii) control in order to account or consider one or more aspects of BESS.

In one or some embodiments, the computer-based learning may be supervised. Alternatively, the computer-based learning may be unsupervised. In particular, in one or some embodiments, the computer-based learning may be user-assisted, such as by inputting domain knowledge. For example, the Central Control System (CCS), discussed further below, may comprise an intelligent agent that is configured to learn faster using domain knowledge. More specifically, in the context of reinforcement learning, the CCS may engage in apprentice learning.

In one or some embodiments, reinforcement learning may comprise: sensing one or more inputs; generating output(s) to control the battery asset(s); and receiving feedback (e.g., feedback from the dispatch of power, such as voltage response at the POI(s); feedback from the battery asset(s), such as voltage/current at the battery asset(s)); indication that the command(s) were rejected by the EMS, effectively establishing boundaries or physical limits of control). As discussed further below, various inputs may be sensed including from part(s) of the grid (e.g., one or more POIs) and/or from one, some, or each of the battery assets. As one example, inputs may be sensed at the POI(s), such any one, any combination, or all of voltage, current and/or frequency at the POI(s). As another example, one or more aspects of the battery asset(s) may be sensed, such as any one, any combination, or all of voltage, current, depth of charge, number of charge cycles, current depth of charge (e.g., current amount that battery can be charged up to, which may degrade over time), etc. at the battery asset(s). Further, various outputs may be generated, as discussed further below. As one example, the CCS may transmit one or more commands to the EMS in order for the EMS to control its respective battery asset(s). For example, the command may indicate an amount of active or reactive power needed from the respective battery asset(s). As another example, the command may indicate a power factor. Regardless, the EMS, responsive to receiving the command(s), may analyze the command and control its respective battery asset(s) accordingly.

Further, as discussed in more detail below, the CCS may be configured to globally optimize with regard to battery health, whereas the EMS may be configured to locally optimize with regard to battery health. Because reinforcement learning may be computationally expensive, in one or some embodiments, the reinforcement learning is limited to the CCS, thereby limiting reinforcement learning to the global optimization level (as opposed to the local optimization level).

For example, the domain knowledge may indicate permissible operations of the grid (e.g., permissible voltage fluctuations), which may assist in the CCS's reinforcement learning (e.g., acceptable bounds for the reactive injection) in reducing the search space. Alternatively, the CCS may train without the assistance of domain knowledge.

In one or some embodiments, the interdependent manner of performing both (i) and (ii) may comprise automatically serially performing (i) and then (ii). For example, the computer-based learning may comprise a bi-level nested reinforcement learning framework where an inner loop determines the actions (e.g., the optimal actions as defined by selecting values for one or more controllable variables in the grid) to comply with the one or more standards (e.g., maintain voltage and thermal limits of the monitored facilities) and an outer loop that determines one or more limits considering the battery SOH (e.g., the outer loop optimizes the battery State of Charge (SOC) limits of the BESS in real-time).

Thus, in one or some embodiments, the CCS, in generating its commands, may receive input from one or more types of sources, including one or both of: data from one or more parts of the grid (e.g., one or more points of interconnection (POIs)); or data from one or more battery assets. For example, the battery assets may be electrically connected to one or more POIs in a respective grid. In order for the CCS to generate its commands to the battery assets, the CCS may receive data sensed from the one or more POIs. Moreover, one or more battery assets (such as one or more sets of batteries) may service a respective POI. In such an instance, the CCS may receive sensed input from any one, any combination, or all of the battery assets (such as sets of batteries) that service the respective POI.

Further, in one or some embodiments, the CCS may generate one or more types of outputs. Generally speaking, in one or some embodiments, the CCS may be configured to generate a command output that is both within the recommended guidelines (e.g., FERC Order No. 827) and more narrowly tailored than the recommended guidelines. As discussed above, FERC Order No. 827 may require providing reactive power support within the range of 0.95 to 1.05 power units at the transmission voltage side of the generator step-up transformer. In compliance with FERC Order No. 827, the CCS may generate one or more outputs that are within a subset of the designated range (e.g., 0.95 to 1.05 power units). As one example, the CCS may generate an output that is a narrower designated range (e.g., less than 75% of the FERC Order No. 827 range, less than 50% of the FERC Order No. 827 range (such as 0.97 to 1.03 power units); less than 25% of the FERC Order No. 827 range; less than 10% of the FERC Order No. 827 range (e.g., 0.96 to 0.97 power units); less than 5% of the FERC Order No. 827 range (e.g., 0.96 to 0.965 power units); less than 4% of the FERC Order No. 827 range; less than 3% of the FERC Order No. 827 range; less than 2% of the FERC Order No. 827 range; less than 1% of the FERC Order No. 827 range; etc. As another example, the CCS may generate an output indicative of a setpoint (that is within the FERC Order No. 827 range) and a confidence interval (e.g., a range around the setpoint, which is less than the FERC Order No. 827 range). For example, the CCS may generate an output of 0.99 power units with a confidence interval of +/−predetermined percentage (e.g., +/−5%, +/−10%, +/−20%, etc.).

Thus, the CCS generates an output that is more narrowly tailored than the recommended guidelines (e.g., a sub-range of the 0.95 to 1.05 power units). This is unlike what is typically done, where the EMS, either by being pre-programmed with the recommended range (e.g., 0.95 to 1.05 power units) or by receiving the recommended range, selects within the recommended range based solely on its own limited local knowledge without any regard to other factors or inputs. In particular, the EMS may typically operate under rule-based control, such as hard coded look-up table based controls (e.g., if the sensed voltage is X, generate a predetermined output) without any regard to computer-based learning.

As discussed above, the CCS may generate an output command to control one or more POIs. In one or some embodiments, a single set of battery assets may be used to service the one or more POIs. In one example, a single battery asset (e.g., a single BESS system) may be assigned to service (e.g., provide power to or received power from) a single POI. In another example, multiple battery assets (e.g., a first BESS system, a second BESS system) may be assigned to service the single POI. In such an instance, the CCS may send different commands to control the grid at the single POI.

In still another example, multiple different battery assets may be assigned to provide power to different POIs (e.g., a first BESS system designated to supply power to a first POI, a second BESS system designated to supply power to a second POI, etc.). In such an instance, the CCS may send different commands to control the grid at the multiple POIs. In practice, the CCS may receive, as input, voltage sensed at the multiple POIs, whose voltages may be different from one another depending on the load at a respective POI and the overall grid conditions at the respective point in time, as discussed above. Thus, with different inputs, the CCS may provide different controls for the different battery assets (e.g., the different sets of batteries) in order to provide power to each of the respective POIs while also accounting for the health of each respective battery asset assigned to a respective POI. Further, in practice, the CCS, in tailoring the command for the respective POI, may sense one or more aspects of the respective battery assets (e.g. the respective set of batteries) assigned to service the respective POI. In this way, the CCS may tailor the command to the respective POI both so that the respective battery assets (e.g., respective set of batteries) services the respective POI within the designated guidelines (e.g., FERC Order No. 827) and for improved battery health for the respective battery assets (e.g., respective set of batteries). Thus, in the given example, the CCS may generate first command(s) for the first battery asset (e.g., first set of batteries) designated to service the first POI (tailored to the voltage sensed at the first POI and voltage/temperature sensed from the first set of batteries), and may generate second command(s) for the second battery asset (e.g., second set of batteries) designated for supplying power to the second POI (tailored to the voltage sensed at the second POI and voltage/temperature sensed from the second set of batteries).

Alternatively, or in addition, different battery assets (e.g., different sets of batteries may) service a respective POI. The different battery assets (e.g., different sets of batteries) may vary in one or more respects, such as any one, any combination, or all of: different ages; different capacities; different depths of charge; different numbers of charge cycles, etc. In this regard, the CCS may send different commands to the different battery assets for the respective POI. For example, the CCS may send a first command to a first EMS associated with a first battery asset and a second command (that is different from the first command) to a second EMS associated with a second battery asset. As one example, the CCS may issue a first command to the first EMS indicating 0.98 per unit voltage with 20% of reactive power and may issue a second command to the second EMS indicating 1.02 per unit voltage with 30% of reactive power. As another example, the CCS may issue a command in proportion to the MVA rating for the respective battery assets. In particular, responsive to automatically determining that the first battery asset is rated at 100 MVA and the second battery asset is rated at 30 MVA, the CCS may issue a command that the first battery asset supplies more reactive power since the first battery asset has more reactive power capability. In a situation where the overall reactive power demand is 50%, the CCS may issue commands to the first EMS for the first battery asset to provide 30% reactive power and the second EMS for the second battery asset to provide 20% reactive power. In this way, the CCS may account for the differences in the health of the first battery asset and the second battery asset (e.g., different ages, different depths of charge, different numbers of charge cycles, etc.).

In practice, the CCS may receive sensor input from both the respective POI (e.g., voltage, etc.) and from the different battery assets (e.g., voltage/temperature from the first battery asset and from the second battery asset, etc.). In this regard, the CCS may tailor the commands to the different battery assets in order to: comply with the standard (e.g., send a command to control voltage at the respective POI according to FERC Order No. 827); and factor the health of the different battery assets.

Still alternatively, different battery assets (e.g., different sets of batteries) may service different POIs. In such an instance, the CCS may receive sensor input that senses voltage at the different POIs and senses one or more aspects of the different battery assets servicing a respective POI (e.g., sensing voltage/temperature at a first battery asset servicing a first POI; sensing voltage/temperature at a second battery asset servicing the first POI; sensing voltage/temperature at a first battery asset servicing a second POI; sensing voltage/temperature at a second battery asset servicing the second POI; etc.). In this way, the CCS may tailor the commands to the different battery assets for each of the different POIs in order to: comply with the standard (e.g., commands sent to control the voltage at each of the different POIs comply with FERC Order 827 within the designated range; however, the commands sent to the different POIs need not identical and may be tailored to one or both of: the power needs at the respective POI; and factor in the health of the different battery assets that service the respective POI. In the given example regarding the first POI, the CCS may generate a first output command for the first battery asset servicing the first POI and a second output command for the first battery asset servicing the first POI, with the second output command being different from the first output command. In particular, the CCS, in generating the first output command, may consider the health of the first battery asset. Likewise, the CCS, in generating the second output command, may consider the health of the second battery asset. As one example, the first battery asset may be older than the second battery asset. As such, the CCS, based on its reinforcement learning, may determine to request more power from the second battery asset than the first battery asset (e.g., request 0.99 power units at 30% from the second battery asset versus 0.97 power units at 20% from the first battery asset). In this way, the CCS may consider the specific health (different ages, different current voltages, different current depths of charge, different numbers of charge cycles, etc.) in the different battery assets in generating the respective commands.

As discussed above, computer-based learning may be used for the CCS. In the context of the CCS controlling different POIs and/or different battery assets servicing the different POIs and/or different battery assets servicing the same POI, the computer-based learning algorithm may comprise a multi-agent machine learning algorithm. In particular, multiple different agents may operate, with the respective different agents being assigned to different POIs and/or to different battery assets. In this regard, the CCS, using the multiple different agents, may generate different set points for the different POIs and/or the different battery assets.

In this regard, the inner loop, which may be automatically performed first, may assist in maintaining the grid voltage and thermal limits in steady state through an optimized cumulative return and need not require a priori information of the network topology (e.g., N−1, N−2, etc.). Specifically, the reinforcement learning agent may only need the knowledge of the current state and the current reward to determine the policy, such as the optimal policy, and does not require a priori knowledge of any system input or the detailed system modeling. Likewise, various aspects of the battery, such as the state of health (SOH) of the battery, may be non-linear in nature. As such, the selected control may avoid clamping the battery SOC to a fixed level, as this might increase the number of charge/discharge cycles and in turn affect the battery life.

As discussed above, operations may have a deleterious effect on the battery assets, such as any one, any combination, or all of: the initial state of charge (SOC) of the batteries; the final SOC; the rate at which the batteries are used; the frequency at which the batteries are used; etc. For example, the degradation (e.g., aging) rate of the battery may be affected by several factors including any one, any combination, or all of: temperature at which the battery operates; charge and discharge voltage; charge and discharge current; the level at which the battery is charged or discharged; state of charge; depth of discharge; charge voltage; or C-rate (e.g., the governing measurement of what current a battery is charged or discharged at).

For example, with regard to temperature, prolonged cycling under high temperature may shorten battery life. Extremely low temperatures may increase the battery IR and may decrease significant amount of discharge capacity. A battery that provides 100 percent capacity at 27° C. (80° F.) will typically deliver only 50 percent capacity at −18° C. (0° F.). The batteries' capacity at low temperatures (0° C., −10° C., −20° C.) are lower than the ones at higher temperature (25° C., 40° C., 60° C.). In addition, charging Li-ion batteries at low temperatures (below 15° C.) leads to lithium plating due to the slow-down of the intercalation of lithium ions. This process may accelerate Li-ion battery degradation by increasing battery IR and decreasing battery discharge capacity.

As another example, depth of discharge (DOD) may have a dominant effect on the cycle life of Li-ion batteries. Deep discharges may cause pressure in Li-ion cells and damage negative electrode cites, which may accelerate capacity loss and possible cell damage. Generally speaking, the higher the cycling DOD, the shorter the battery cycle life. DODs above 50% may be considered deep discharge. When a Li-ion battery is discharged from 4.2V to 3.0 V, roughly 95% of its energy is spent, and continued cycling may result in the shortest battery life. Full discharge should generally be avoided during Li-ion battery cycling to reduce capacity loss. Manufacturers may use the 80% DOD formula to rate a battery, which means only 80% of the input energy is delivered during battery use and another 20% is reserved to achieve longer battery service life.

With regard to charge voltage, high charge voltage may give Li-ion batteries high capacity and may enable prolonged battery runtime. However, it may not be recommended to fully charge Li-ion batteries. Charging Li-ion batteries above 4.1V/cell may lead to lithium plating, which may increase the loss of lithium ions as they form metallic lithium on the anode. As discussed above, this process not only may decrease the battery capacity, but also might lead to internal short circuiting and cause fires. Thus, generally speaking, the higher the charge voltage, the faster the capacity may degrade and the shorter the cycle life.

As still another example, cycle bandwidth may comprise the range of a battery being discharged expressed in SOC. For example, ‘100-25@20C’ means discharge the battery from 100% SOC to 25% SOC at 20 C-rate and the bandwidth is ‘100-25’. DOD of ‘100-25’ bandwidth is 75%. Generally speaking, when discharging a battery from 100% SOC, the higher the DOD, the faster the degradation. In order to prolong battery life but also maximize use of the battery capacity, batteries may be cycled in mid-state-of-charge.

With regard to charge current/C-rate, generally speaking, high C-rates may cause increasing Internal Resistance (IR), loss of available energy, safety issues, and irreversible capacity loss. In particular, high C-rates may cause lithium plating. When the Li-ion battery is charged with a high current, this may force the lithium ions to move at a faster rate while access to the anode surface is limited. Thus, lithium ions may accumulate on the surface of the anode and form metallic lithium. This process may be accelerated when the battery fast charging at low temperatures and high SOC. Moreover, high charge and discharge current may also cause more energy loss as part of the energy is transferred to heat because of battery IR. When the C-rates exceed a certain level, the elevated temperature inside the battery may also cause stress, damage the battery, and accelerate capacity loss.

With regard to cycle frequency, a large number of cycles may increase the solid electrolyte interface (SEI) layer growth and may cause mechanical stress to Li-ion batteries, especially when the cycling is frequent (e.g., 4 cycles or more per day).

Thus, the CCS may consider various aspects of operation of the battery (e.g., the number of cycle increases; whether using a respective battery will necessitate a higher C-rate; the cycle bandwidth (e.g., a current state of charge of the respective battery and whether usage of the respective battery will result in discharging the respective battery outside of its designated cycle bandwidth); depth of discharge of the respective battery (e.g., whether using the battery will result in a deep discharge); current temperature (e.g., a temperature sensor associated with the respective battery indicating whether the temperature is greater than a certain amount (indicating a high temperature) and/or whether the temperature is lower than a certain amount (indicating a low temperature); responsive to the CCS receiving an indication of temperature (such as indicating a high temperature), the CCS may determine whether to select the respective battery for use (e.g., for discharge)).

Thus, the batteries may have recommended ranges in which to operate. Even while working within those recommended ranges, the batteries may degrade. As such, the reinforcement learning may be configured to learn how to reduce the aging effect on operation. As one example, reinforcement learning may include learning about the various aspects of battery operation that may affect battery health, such as any one, any combination, or all of the following influences on battery health: temperature; DOD; charge voltage; cycle bandwidth; charge current/C-rate; cycle frequency; etc. In particular, various factors may influence or affect the battery aging including any one, any combination, or all of: temperature range of operation; battery charge cycle (e.g., the frequency at which the battery charge cycle occurs; the amount of battery draining or the amount to full recharge; etc.) overcharging; etc. Hence, the reinforcement learning framework in the outer loop may learn the optimal SOC range (e.g., for each of the various factors) for varying network topologies (e.g., System Normal, N−1, N−2, etc.) because the SOC range may be an important factor in determining the battery SOH degradation. In this way, the outer loop may automatically globally optimize the battery SOH degradation and may help to reduce or minimize the amortized battery replacement cost.

Thus, the computer-based learning may perform in an interdependent manner both control of the grid in any mode to maintain grid requirements control in order to account or consider one or more aspects of BESS. Various modes of control are contemplated. By way of example, grid control may be in any one, any combination, or all of several quadrants, such as Quadrant I (both powers flow positively in which there is an import of active power and reactive power); Quadrant II (reactive power flows positively and active power flows negatively); Quadrant III (both powers flow negatively in which both active power and reactive power are received); and Quadrant IV (reactive power flows negatively and active power flows positively). As discussed in more detail below, the computer-based learning may operate in any one, any combination, or all of Quadrants I, II, III, or IV. Below are examples in the different quadrants for purposes of illustration, not to be limited to operation of the computer-based learning in the respective quadrants.

As one example, the inner loop may generate a recommendation for grid control, such as commanding an injection of reactive power between 20-30% and/or commanding sending 100 MW into the grid. With the outer loop, the automatic implementation of the recommendation may be selected in order to account for the battery SOH (e.g., determine a current state of the grid and select one or more steps to implement the recommendation to improve or optimize for battery SOH). In the given example, the current state of the grid may be considered in order to determine, for optimizing the battery SOH, what values to implement, such as which percentage within the recommended range of 20-30% of reactive power to select, and/or how to achieve the selected power. For example, potential values for control of the grid, such as a recommended range of control or a recommended range of values for at least one operating parameter, may first be selected so that the grid operates within predefined parameters. After which, value(s) within the recommended range of control in which to control the grid (e.g., the grid control values) may be selected based on battery SOH. In the given example of a recommended range of 20-30% of reactive power, the value within the range of 20-30% of reactive power may be selected based on the battery SOH (e.g., optimizing the battery SOH). Alternatively, or in addition, once the value(s) at which to operate the grid are selected to comply with grid control standards, the transition to those values may be made based on the battery state of health. Again, in the given example, once the value within the range of 20-30% of reactive power is selected (e.g., 22.1% as the desired value for the operating parameter), the rate of transition to that value may be made by accounting for the battery SOH (e.g., the rate of transition from a current value of the operating parameter to the desired value of the operating parameter). The implementation of the rate of transition may be performed in one of several ways. In one way, the CCS may determine the timing at which the commands are generated and transmitted so that the rate of transmission is met (e.g., a transition from a current value of 10.2% to the desired 22.2% may be achieved over the designated time period by commanding the transition in steps, such as first from 10.2% to 11.0%, etc. until the ultimate value of 22.2% is reached at the end of the designated time period). Alternatively, the CCS may send the command with the desired value and the rate of transition (e.g., the command includes both the value of 22.2% and the designated time period over which the change is to occur). In this way, the CCS is configured to control the part or all of the power grid at the rate of transition from the current value of the at least one operating parameter to the desired value of the at least one operating parameter. Thus, one or more of the values (such as potential values) for control of the grid may be automatically selected (e.g., the selection of the percentage of active or reactive power, such as 22% within the range of 20-30% as recommended by the inner loop, and/or the implementation of the commands to achieve the selected percentage of active or reactive power, such as the rate at which to increase the injection of reactive power to 22%, with one or both being selected to improve or optimize the battery SOH). In this regard, the selected values may be for one or both of a current desired state of the grid or of a desired transition to the desired state of the grid (e.g., a rate at which to change values in order for the grid to ultimately operate at the desired state), with the values being selected to optimize control the grid and to optimize the battery SOH.

As another example, the BESS may be configured to provide active power-frequency control. For active power-frequency control, any one, any combination, or all of the following may be provided by the user and/or by default settings: deadbands; droop settings; and other response characteristics. Over time, the CCS may be configured, such as via reinforcement learning, to learn to improve or optimize the active power frequency characteristics.

Thus, in one or some embodiments, the CCS may use reinforcement learning in order to control (via commands to one or more EMSs) the one or more battery assets in a system. In one or some embodiments, the reinforcement learning is performed without human input. Alternatively, the reinforcement learning is performed with human input. For example, a human (such as an operator) may provide input in the form of rules, tables, or the like in order to assist in the reinforcement learning.

As discussed above, the CCS may receive inputs from the grid (e.g., voltage at the POI) and from the battery asset(s) (e.g., current charge state, current number of charge cycles, current depth of charge, etc.). Responsive to these inputs, the CCS, using reinforcement learning, may generate the commands to the battery asset(s). In one or some embodiments, the reinforcement learning may dynamically weight the various inputs, such as the inputs from the grid and/or from the battery asset(s), in order to generate the commands for output. In one or some embodiments, the weights may be initially equal, but may dynamically change. As one example, the weights may dynamically change over different iterations of the CCS sending commands and receiving feedback, with the reinforcement learning dynamically modifying the weights as a manifestation of learning. Alternatively, or in addition, an operator may provide input to the reinforcement learning, such as in the form of rules or the like, in order to dynamically modify the weights. As one example, the operator may input a rule whereby responsive to determining that a respective battery asset's age is greater than 40 years, the CCS will not consider the respective battery asset's health (or consider the health of the respective battery asset's less). This rule is a manifestation of the operator's belief that because the age of the respective battery asset is greater than a predetermined amount, the respective battery asset will likely fail soon so that the system can drive the respective battery asset harder (relative to other battery assets whose health is being protected). As another example, the operator may input a rule whereby responsive to determining that the respective battery asset's, when fully charge, has no more than a predetermined percentage of its full charge when new (e.g., the respective battery asset can charge no greater than 25% of its original full charge), the CCS will not consider the respective battery asset's health (or consider the health of the respective battery asset's less). Again, this rule is a manifestation of the operator's belief that the health of the respective battery asset has degraded past a predetermined metric so that health is no longer considered (or is less considered). Thus, in one or some embodiments, the reinforcement learning, cither with or without human input, may dynamically generate outputs based on various factors associated with a respective battery asset (e.g., age, number of charge cycles, current depth of charge, etc.) so that the CCS can dynamically modify prioritizations with regard to health of the battery assets over the lifetime of the battery assets.

In one or some embodiments, the speed of response in such a control mode may depend on primary frequency response needs, if given as a priority by the user or the CCS, thereby modulating the speed of response in an acceptable margin to optimize the battery SOH. Generally speaking, the capacity and/or energy needed to support interconnection frequency control is relatively small and for short period of time. However, the number of times active power-frequency controls change power output outside of the defined deadbands may have a small but finite impact on battery lifespan. As such, the CCS may consider the battery SOH, for example, with regard to deadbands. As discussed above, the user and/or the default may set the range of potential values. From this, the CCS may select, from the range of potential values, the predefined value for the deadband so that the controller does not allow the system to respond to frequency deviations that do not exceed the predefined value while also accounting for battery SOH.

In addition or alternatively, potential droop settings may be user-specified and/or by default. From this, the CCS may select, from the potential droop settings, the defined droop setting(s). In one or some embodiments, the CCS may automatically implement the defined droop setting(s) without user confirmation. Alternatively, the CCS may be presented with one or more options from which to choose. For example, the user may be presented with a first option of a droop of 3%, which may preserve battery health more than having the droop at 5%. In turn, the user may then select from the options presented, and thus may prioritize either the battery health or how stringent grid requirements are depending on the location of this system. As such, the CCS's consideration of the battery SOH may markedly improve the battery health during active power-frequency control.

As still another example, the system may provide reactive power-voltage control in both charging and discharging modes. In this regard, the system may be configured to support the grid voltage by controlling its Point of Measurement (POM) voltage (alternatively termed POI measurement) within a reasonable range during normal and abnormal grid conditions through reactive power injection. In one or some embodiments, the CCS, through machine learning, may control in this situation as well. For example, the POM may be defined by the user and/or by default. For the range, the CCS may learn what the optimized range for the POM is, even with little user feedback (e.g., the learning performed by the CCS may be assisted such as by using domain knowledge, as discussed above).

As yet another example with regard to reactive power at no active power being input, the system may be configured to provide dynamic reactive power to support grid voltage while not discharging or charging using active power. Again, in such an instance, the CCS may be configured to coordinate all these control modes using the reinforcement learning controller giving global commands to the EMS maximizing battery state of health, as discussed further below.

In turn, after automatic selection of the one or more values for control of the grid, the control of the grid, with the selected one or more values, may be automatically implemented. For example, in one embodiment, the automatic implementation may occur without any operator input. Alternatively, the automatic implementation may be implemented by first automatically outputting the selected one or more values to an operator for operator approval. After approval by the operator, the system may automatically implement the selected one or more values.

The automatic intelligent control may be manifested within the system in one or several ways. In one way, a central control system (CCS) may be used in order to perform the automatic interdependent determinations of (i) and (ii), such as automatically performing the inner loop and then the outer loop. In one or some embodiments, the CCS may be located in one or more parts of the system. In one example, the CCS may be located within a server sitting on the Internet, with the ability to communicate with various other devices, such as communicating (directly and/or indirectly via one or more intermediate devices) with any one, any combination, or all of: the Advanced Supervisory System Controller (ASSC), interchangeably termed a Supervisory System Controller; the Energy Management System (EMS); or the Battery Management System (BMS). Alternatively, or in addition, the CCS may be located at or within grid hardware (e.g., within substation control hardware). Still alternatively, or in addition, the CCS may be located at or within control hardware of the BESS system. In any instance, the CCS may automatically communicate with the various other devices via wired and/or wireless communication. In addition, in one or some embodiments, the ASSC may automatically work in combination with the CCS so that the CCS may communicate (e.g., send information to and/or receive information from) with the various parts of the system, such as the EMS and/or the BMS.

Further, the intelligent control may be implemented in multiple tiers. For example, in one or some embodiments, at least two tiers may be included, such as: a global control tier (which may comprise the CCS automatically performing the interdependent determination of (i) and (ii), such as performing the inner loop and the outer loop, for recommended grid parameter values); and a local control tier (which may comprise the EMS to automatically implement the recommended grid parameter values based on local or specific knowledge of the respective battery asset(s) under the respective EMS control). In one or some embodiments, the multi-tiered intelligence may be divided amongst the different tiers. For example, the global control tier, which may be manifested in the CCS, may include intelligence to determine the global or system-wide control (e.g., automatically controlling part or all of the grid and/or considering part or all of the battery SOH). Further, the local control tier, which may be manifested in the EMS, may include intelligence specific to the battery asset(s) (e.g., more detailed information on the batteries in order to perform the particular automatic control of the batteries) in order to determine the implementation on a local level. In practice, the CCS, as the global control tier, may provide automatic recommendations or guidelines for control. In turn, the EMS, as the local control tier, may receive the recommendations, and using its own intelligence, the EMS may automatically implement the recommendations (e.g., based on a granular or local analysis due to additional information on the batteries, modify or change one or more of the recommendations or the recommended values received from the CCS in order to control one or more Power Conversion Systems (PCS)). In this way, the intelligent control may be tailored to the different tiers and may be at least partly decentralized (e.g., part of the intelligence being centralized and another part being localized), with overall system control being performed in the global control tier and with specific battery control being performed in the local control tier.

Thus, in one or some embodiments, the CCS has observability of one or more parts of the grid (such as the entirety of the grid) and has knowledge of battery asset health, thereby generating control outputs examining both the grid and the battery asset health. In contrast, the EMS does not have the observability of the grid to the extent that the CCS does, instead being focused on its specifically assigned battery asset health. Further, the accounting of battery asset health is different at the global level (as performed by the CCS) than at the local level (as performed by the EMS), as discussed in more detail below.

Thus, in one or some embodiments, the CCS may be decoupled, such as one or both of physically (e.g., being located in different physical locations) and/or functionally (e.g., the CCS performs system-wide control and the respective EMS performs location functional control), from the EMS. In particular, the CCS may be trained for global control, whereas the EMS may have access to local cell information that the CCS either does not have or does not need to have. As discussed above, the reinforcement learning algorithm enables the CCS to learn how its global commands are finally being implemented by the EMS through local controls. For example, if the CCS commands the EMS that the battery set points in a particular control mode are to be ‘x’ and ‘y’ and the EMS finally implements ‘a’ and ‘b’, where ‘x-a’ and ‘y-b’ are both within acceptable tolerance (pre-defined or otherwise), then the feedback to the CCS indicates to the CCS that its command to the EMS is within acceptable limits. In contrast, if the tolerance is too high (e.g., ‘x-a’ and ‘y-b’ are not within acceptable tolerance), the CCS may learn in time to adjust its future commands to the EMS so that the modifications by the EMS are within the acceptable limits.

As discussed in more detail below, the EMS, with its local intelligence, attempts to determine the optimal dispatch of each cell or battery string in order to meet the CCS command. However, the EMS may deviate from the CCS commands for a variety of reasons, such as any one, any combination, or all of: based on the EMS determining that the CCS commands are outside the physical capability of the BESS system; based on the EMS being cognizant of downstream activity that the CCS is not; and based on the EMS's independent assessment as to the steps to improve or preserve the battery SOH (e.g., the battery cells may not be balanced when the CCS command arrives; after rebalancing of the battery cells, the EMS may better honor the CCS commands).

For example, a respective EMS may control a battery asset that is divided into multiple subparts (such as multiple cells). The EMS, as the local control of the battery asset, may have additional information regarding the battery asset (such as additional knowledge of the multiple subparts) that the CCS does not, such as capability of the battery asset (e.g., a maximum amount that the battery asset may produce) and/or the current state of the battery asset (e.g., the current state of one or more of the multiple subparts of the battery asset, such as the current state of the multiple cells). Responsive to the respective EMS receiving the CCS command, the respective EMS may determine one or both of: (i) determining whether the CCS command exceeds the current capability of the battery asset; or (ii) determining how to allocate the CCS command to the multiple subparts of the battery asset (in the instance where the battery asset is divided into subparts). In one particular example, responsive to the CCS command indicating to the respective EMS to produce 0.75 leading power, with the maximum capacity of the battery asset producing 0.85 leading power, the respective EMS will control the battery asset accordingly (e.g., only to its maximum of 0.85 leading power) and communicate this to the CCS. In response, the CCS may interpret the feedback as a boundary condition and update its learning so that future commands to the respective EMS will abide by the boundary condition. In another particular example, the CCS command indicates X amount of power (or the like). The respective, EMS, responsive to receiving the CCS command, examines the current state of the individual cells of the battery asset, and then executes the global level CCS command on the local level to the individual cells of the battery asset (e.g., the CCS command may indicate “10” with the respective EMS determining how to allocate the command of “10” to the individual cells of the battery asset based on the current state of the individual cells). Thus, the respective EMS, being closer to the individual cells both proximately and information-wise, may better allocate the global CCS command on the local level.

In one or some embodiments, the CCS may access one or more priorities of operation. In a first embodiment, the user may input the one or more priorities of operation for storage and later access by the CCS. Alternatively, or in addition, the one or more priorities may be predetermined and stored in at least one memory for later access by the CCS. For example, the user may be presented with one or both of the following choices: giving absolute priority to the battery SOH over a desired response; or giving the battery SOH a lower priority over other choices (such as a desired response in controlling the grid). In the instance where the user selects giving absolute priority to the battery SOH, the CCS, in its operation, may access the stored priority in order to generate the response. In practice, the CCS may not always generate the desired response; nevertheless, the response may be the most optimized given the current grid situation and battery control mode selected. Conversely, in response to the user assigning the battery SOH a lower priority over the desired response, the CCS is configured to generate the exact desired response though the CCS may still attempt to optimize the battery SOH as much as possible when generating the exact desired response. Hence, in one or some embodiments, the CCS may be tailored based on one or more user inputs, such as one or more control goals (e.g., the CCS generates the one or more commands based on the priority indicated by the user or pre-set). Further, the CCS may observe the final output and how this final output has affected the battery SOH overtime by gathering battery status information, such as temperature, etc.

Thus, a cooperative wide-area monitoring may be achieved through the digital intelligence when a BESS that may operate in all four quadrants interacts with nearby shunt compensating devices to provide voltage and thermal support during contingency scenarios. Thus, in one or some embodiments, the disclosed methodology may achieve bulk power system wide-area monitoring and control through a cooperative interaction between the BESS and shunt compensating devices to comply with one or more standards (e.g., achieving voltage and thermal limits during contingencies) and to consider the battery SOH (e.g., reducing or minimizing the battery degradation).

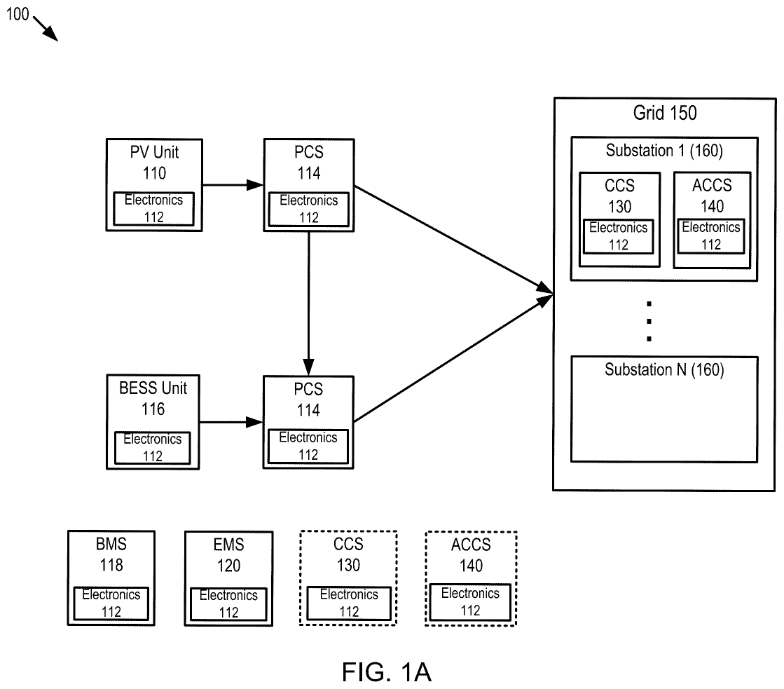

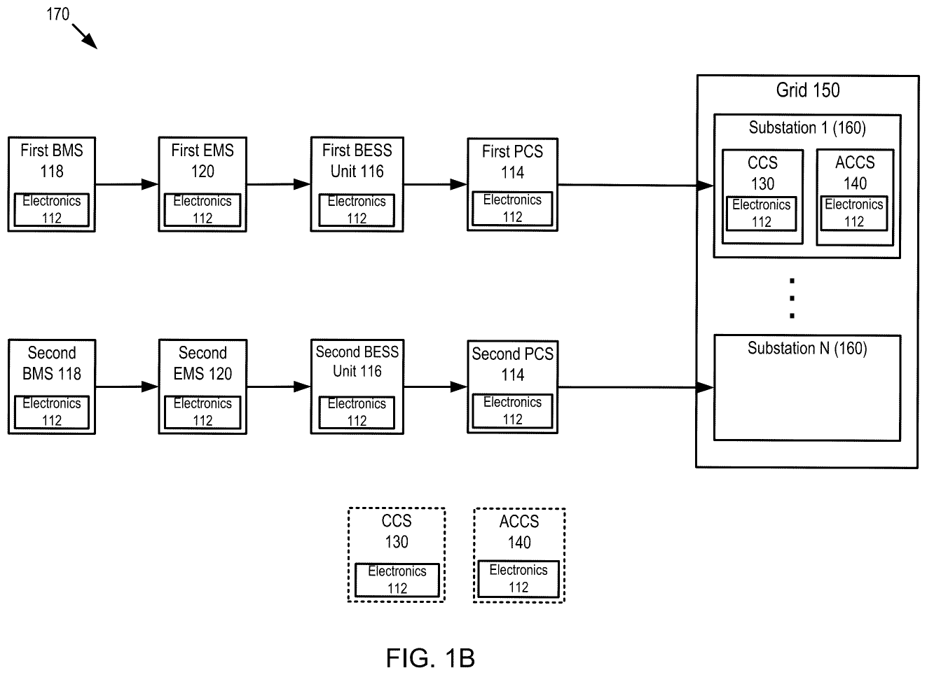

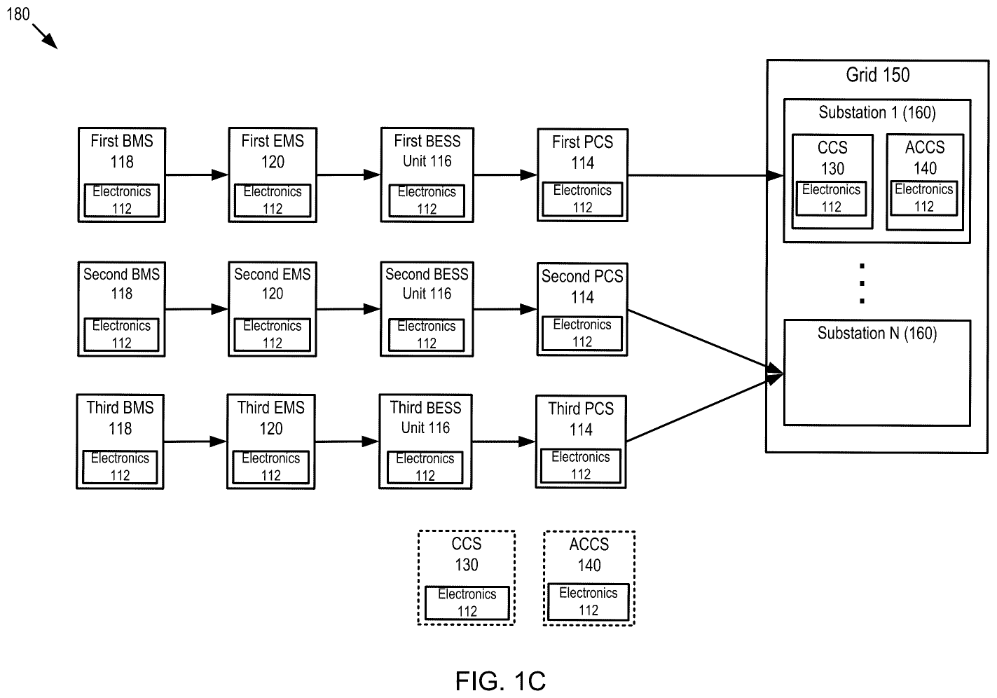

Referring to the figures, FIGS. 1A-C is example block diagrams illustrating high-level system architectures for the system of intelligent BESS control for bulk power system monitoring and control. Specifically, FIG. 1A is a first example block diagram 100 illustrating a high-level system architecture for the system of intelligent BESS control for bulk power system monitoring and control. The system architecture in FIG. 1A includes a grid 150 which may include various hardware, such as one or more substations, including substation 1 (160) to substation N (160), where N may be any integer number. Further, the system architecture may include a BESS system, which is an example of a battery asset and may include one or more batteries (e.g., BESS unit 116) and various other electronics. The various other electronics may include any one, any combination, or all of: power generation (such as solar power generation, which may comprise photovoltaic (PV) unit(s) 110); PCS 114; BMS 118; EMS 120; CCS 130, or ASSC 140. In one or some embodiments, any one, any combination, or all of PCS 114; BMS 118; EMS 120; CCS 130, or ASSC 140 may comprise the power grid control system.

In one or some embodiments, the BESS, which may comprise the BESS unit 116, may comprise one or more rechargeable battery assets (which may be divided into one or more individual cells) configured to store energy from one or more sources and discharge energy when needed. BESS, in combination with control electronics, such as any one, any combination, or all of the CCS 130, the EMS 120, the BMS 118, may provide any one, any combination, or all of the following support functions to the power grid: frequency regulation; ancillary services/grid stability (e.g., BESS systems may charge and discharge quickly in order to balance the grid on the demand and/or the production side); voltage support/stabilization; emergency response systems (e.g., BESS systems may provide emergency response services of any one, any combination, or all of frequency regulation, ramping, and voltage support in a manner that is similar to energy reliability services from synchronous facilities); operating reserves; reduction of grid congestion; ramp rate control; energy arbitrage; capacity firming; peak shaving; or black start.

The BESS may include: battery modules (which may comprise BESS unit 116 and which may be connected in series and/or parallel to obtain the required capacity); storage enclosure with thermal management; and either contain or work in conjunction with the CCS 130, the BMS 118, the PCS 114, and the EMS 120. FIG. 1A illustrates that the BMS 118, PCS 114, and EMS 120 as separate devices, though it is further contemplated that any one, any combination, or all of the CCS 130, BMS 118, PCS 114, and EMS 120 may be part of the BESS (e.g., proximate to BESS unit 116), as discussed further below.

The BMS 118 may monitor, such as continually monitor, a state of the battery asset(s), such as any one, any combination, or all of: the battery asset's output; the battery asset's voltage; the battery asset's temperature; the battery asset's health; the battery asset's fire warning; and the battery asset's SOC. The BMS 118 may also regulate the charging and discharging power based on the input signal.

The PCS 114 may handle the AC-to-DC conversion and/or DC-to-AC conversion, which may use a bi-directional inverter. In one or some embodiments, some or all of the clusters from the battery asset system may be connected to a common DC bus and a further DC bus extended to the PCS 114.

In one or some embodiments, the CCS 130 is configured to be the centralized intelligence of the entire system. In practice, the voltage source converter with advanced controls may allow the inverter to charge or discharge the battery and/or to supply or consume reactive power. The CCS 130 may be configured to automatically orchestrate the flow of information executing a computer-learning algorithm, such as an efficient reinforcement learning-based algorithm, that is configured to optimize the voltage and thermal limits of the monitored facilities taking information from nearby shunt compensating devices and also minimizing the battery degradation and hence the cost of the system in the long term. As such, the CCS 130 may automatically execute the reinforcement learning-based routine to optimize voltage and thermal limits of the monitored facilities while minimizing battery degradation. As discussed further below, the CCS 130 is configured to collect information from various parts of the BESS through the ASSC 140.

In one or some embodiments, the ASSC 140 is configured to automatically coordinate the information flow between the CCS 130, the BMS 118, the EMS 120 and the Power Conversion Systems (PCS) 114. In one or some embodiments, the PCS 114 comprises smart inverters and inverter controller(s). In one or some embodiments, the ASSC 140 is configured to act as the interface between the CCS 130 and the EMS 120. Specifically, the information about the BESS strings may be conveyed from the BMS 118 to ASSC 140. When the CCS 130 automatically requests the BESS operation in a particular quadrant, the ASSC 140, in turn, may send the request to the EMS 120 to automatically choose the optimal protocol for operating in that quadrant while accounting for both the current state of the battery asset(s) and the CCS's demand request. The EMS 120 is configured to calculate the optimal operation of each battery string, which may be automatically implemented either on the ASSC 140 itself or separately in the cloud server or on a separate workstation. In one or some embodiments, the output of the EMS 120 is transmitted to the PCS 114, whose main task is to control the inverter setpoints based on input from the EMS 120. In one or some embodiments, the EMS 120 is configured to automatically execute an optimization algorithm to optimize the power dispatch according to minimal losses, aging, etc. as part of the local control tier. In one or some embodiments, to maintain adequate system redundancy, if the EMS 120 fails, the main ASSC 140 unit may automatically assume responsibility of the dispatch based on a predetermined algorithm (e.g. the power is equally distributed among the available battery strings). In practice, the ASSC 140 may, responsive to receiving an indication of failure regarding the EMS 120 (e.g., either directly by communicating with the EMS 120 or via communication with the BMS 118), the ASSC 140 may be configured to control the respective one or more battery assets for the grid (e.g., the respective batteries for a respective EMS 120 that has failed; the respective batteries for a plurality of EMS 120 that have failed; etc.).

In one or some embodiments, the CCS 130 is configured to automatically assist in achieving wide area monitoring and control with the BESS and nearby shunt compensating devices. In one or some embodiments, the CCS 130 automatically receives as input one or both of the states of the nearby shunt compensating devices and the current BESS state, and automatically executes an optimization routine to calculate the optimized state of the BESS and shunt compensating devices such that voltage and thermal limits of the monitored facilities are within contingency limits and sends this demand request accordingly.

As discussed further below, the EMS 120 may automatically communicate with the CCS 130 (via the ASSC 140) and the BMS 118. In one or some embodiments, the CCS 130 may be configured to automatically determine, based on the dual goals of control of the grid (e.g., a globally optimized recommendation, which may be in the form of one or more control parameters, as to how to control the grid system) and of control of the battery state of health (SOH) (e.g., a globally optimized recommendation for optimized battery SOH degradation, and in turn assisting in reducing or minimizing the amortized battery replacement cost). In turn, the EMS 120 may automatically receive the one or more control parameters and, based on granular analysis by the EMS 120 to implement the one or more control parameters, automatically generate commands to the PCS 114 to implement the one or more control parameters on the granular level. In particular, in implementing the one or more control parameters on the granular level, the EMS 120 may send input signal(s) to either charge or discharge the battery.

Again, responsive to commands from the CCS 130, the EMS 120 may also automatically balance multiple generation resources according to the grid needs (as determined by the CCS 130). Further, the EMS 120, in implementing the commands of generated by the CCS 130, may automatically modify, as part of the local control tier, the various commands received from the CCS 130, as discussed above. In a solar photovoltaic+Storage configuration, the EMS 120, responsive to commands from the CCS 130, may implement a balance of the outputs from PV unit 110 and BESS unit 116 and may automatically decide when to start discharging the battery asset(s) in order to pump stored power to the grid, and when to stop discharging and start charging again based on the production scenario and customer agreements. Alternatively, or in addition, responsive to commands from the CCS 130, the EMS 120 may automatically command whether the BESS unit 116 should be charged from the PV unit 110 or from the grid. Still alternatively, the CCS 130 may automatically send commands to the EMS 120 to provide power to the grid 150 independent of operation of the PV unit 110. Further, FIG. 1A illustrates PV unit 110 as the manner in which energy is generated (e.g., and provided directly to the grid or routed to charge the BESS unit 116). Other types of generator capacity, instead of or in addition to photovoltaic generators, are contemplated to provide power to the grid and/or to charge the BESS unit 116. Moreover, the PV unit 110 and/or the BESS unit 116 may provide power to one or more parts of the grid 150 (e.g., to one or more POIs), such as to a bus resident in substation 1 (160) or in substation N (160).

In one or some embodiments, part or all of the BESS and the various other electronics may be mobile, such as a mobile plug-and-play BESS whereby at least a part of the system, such as the battery assets (e.g., the BESS unit(s) 116 are mobile and may be moved proximate to a part of the grid). The various other electronics, such as any one, any combination, or all of the following may likewise be mobile and may be moved proximate to the grid. As one example, one or both of the BMS 118 and the PCS 114 may be housed within or alongside the BESS unit(s) 116 and thus may be moved along with the BESS unit(s) 116 to a part of the grid. As another example, the PV unit(s) 110 may be mobile and moved along with PCS 114 to be proximate to the part of the grid.

In one or some embodiments, the CCS 130 and/or the ASSC 140 may be part of the grid, such as associated with a substation (see substation 1 (160)). Alternatively, or in addition, the CCS 130 and/or the ASSC 140 may be housed within another part of the system, such as within the BMS 118. This is illustrated in the system architecture in FIG. 1A as CCS 130 and the ASSC 140 in dashed lines. In this regard, in one embodiment, the intelligence, such as the electronics for the global control tier (e.g., the CCS 130 and/or the ASSC 140) may reside within the grid architecture (e.g., the substation). Alternatively, or in addition, the electronics for the global control tier may reside within the mobile portion, such as associated with the battery assets, so that the intelligence residing with the battery assets may be moved to the grid. Still alternatively, the various other electronics may reside elsewhere, such as residing in a server sitting on the Internet.

In any of the implementations discussed, the various other electronics may include functionality, such as any one, any combination, or all of communication functionality, memory functionality, or computing functionality. This is manifested in Electronics 112, which may any one, any combination, or all of communication functionality (e.g., wired and/or wireless communication functionality, such as residing in communications adapter 522, discussed below); memory functionality (e.g., volatile and/or non-volatile memory, such as residing in RAM 506, ROM 508, or storage device(s) 512); or computing functionality (e.g., CPU 802 in combination with memory to execute software to perform the functions described herein). Thus, in practice, the various other electronics may communicate with one another via Electronics 112, may store data to or access data from storage resident in Electronics 112, and may include the computing functionality to perform the various tasks discussed herein with regard to any one, any combination, or all of the PV unit 110, the PCS 114, the BESS unit 116, the BMS 118, the EMS 120, the CCS 130, or the ASSC 140.

FIG. 1B is a second example block diagram 170 illustrating a high-level system architecture for the system of intelligent BESS control for bulk power system monitoring and control in which different battery assets (e.g., first BESS unit 116 and second BESS unit 116) may power different POIs within the grid 150 (e.g., first BESS unit 116 powers bus in substation 1 (160) and second BESS unit 116 powers bus in substation N (160)). As discussed above, the CCS 130 may be configured to automatically receive sensor input (e.g., voltage, current, and/or frequency) from one or more POIs within the grid 150, such as the bus in substation 1 (160) and the bus in substation N (160). The CCS 130 may further be configured to automatically receive input (e.g., age, number of charge cycles, depth of charge, etc.) regarding one or more battery assets, such as first BESS unit 116 and second BESS unit 116. Responsive to receiving the different inputs, the CCS may generate commands to respective EMSs 120 to control the respective BESS units 116. For example, the CCS 130 may automatically generate a first command to automatically send to first EMS 120 to automatically control first BESS unit 116 based on input from POI in substation 1 (160) and input from first BESS unit 116 and a second command to automatically send to second EMS 120 to automatically control second BESS unit 116 based on input from POI in substation N (160) and input from second BESS unit 116. With different commands generated, the CCS 130 may command the different POIs within the grid 150, tailored to the power needs of the different POIs and to the different ages/capacities/state of health of the different battery assets.

FIG. 1C is a third example block diagram 180 illustrating a high-level system architecture that differs from the implementation in FIG. 1B. Specifically, multiple battery assets may supply power to at least one, some, or all POIs within grid 150. This is illustrated in FIG. 1C in which the POI associated with substation N (160) is powered by both second BESS unit 116 and third BESS unit 116. As discussed above, in one or some embodiments, multiple battery assets (such as at least two battery assets, at least three battery assets, at least four battery assets, etc.) may service a single POI. In such an instance, the CCS 130 may be automatically configured to determine, based on input from the single POI (e.g., sensed voltage, sensed current, and/or sensed frequency) and based on input from one, some, or each of the battery assets (e.g., ages/capacities/state of health of the different battery assets) to send different commands to control one, some, or each of the battery assets in order to meet the power needs of the single POI and to consider the state of health of one, some, or each of the battery assets assigned to service the single POI. As one example, the CCS 130, considering the health of each of the battery assets, may determine, due to the current health assessment of one, some, or each of the battery assets, that less than all of the battery assets assigned to the single POI is to service the single POI (e.g., only the second BESS unit 116 is to power the POI in substation N (160)). As another example, the CCS 130, considering the health of each of the battery assets, may determine, due to the current health assessment of one, some, or each of the battery assets, that the battery assets contribute in different amounts to powering the single POI (e.g., based on health of one or both of the first BESS unit 116 and the second BESS unit 116, the first BESS unit contributes more (or less) to powering the single POI than the second BESS unit 116). In this way, the CCS 130 may automatically control the different battery assets that are assigned to service a respective POI.

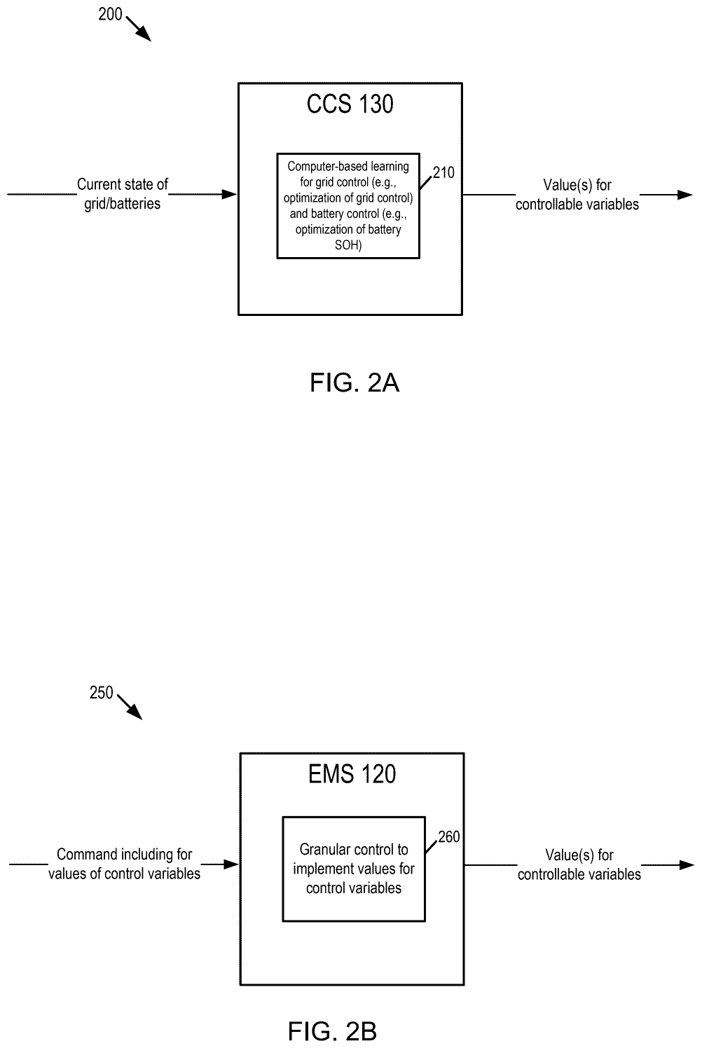

FIG. 2A is an example block diagram 200 for the CCS 130. As illustrated, the CCS 130 may automatically input the current state of one or both of: one or more POIs in the grid; or one or more battery assets. The CCS 130 may automatically output one or more values for controllable variables with regard to the grid, such as one or more POIs in the grid and/or one or more battery assets that service the one or more POIs in the grid. As discussed above, the CCS 130 may automatically generate the one or more values for controllable variables based on computer-based learning for grid control (e.g., optimization of grid control) and/or battery control (e.g., optimization of one or more aspects of the battery assets, such as the SOH of the battery assets). Further, as discussed above, in one embodiment, the CCS 130 comprises a bi-level nested reinforcement learning network. In this regard, the CCS 130 may be trained in a reinforcement learning context. Alternatively, the CCS 130 may be trained in a machine learning context provided that sufficient tagged data may be generated for the training.

In reinforcement learning, there may comprise a decision-maker also known as the agent, with everything outside the agent being known as the environment. At each time step t, the agent may observe the environment's state sₜϵS and on that basis may take an action aₜϵA, where S and A are the sets of possible states and actions, respectively. One time step later, in part as a consequence of the action taken, the agent may receive a numerical reward rₜ₊₁ and finds the environment in a new state sₜ₊₁.

In one or some embodiments, a policy π of the agent is a mapping from each state sϵS to an action aϵA that specifies the action a=π(s) that the agent will choose when the environment is in state s. The ultimate goal of an agent is to find the optimal policy, such that:

$${V}^{π} ( s ) = E \{ {\sum }_{k = 0}^{∞} {γ}^{k} * {r}_{t + k + 1} \vert {s}_{t} = s \} \qquad ( 1 )$$

is maximized for each state sϵS. The value function V^{π}(s) is the expected return when the environment starts in state s at time step t and follows policy π thereafter. γ is a parameter, 0<γ<1, called the discount rate that ensures the infinite sum (e.g., Σₖ₌₀^{∞}γ^{k}*rₜ₊ₖ₊₁) converges to a finite value. More importantly, γ reflects the uncertainty in the future. rₜ₊ₖ₊₁ is the reward received at time step t+k+1.

With regard to state space, the mathematical formulation of the inner loop state space may be defined as:

$$S = \{ s = {[ y , f , c ]}^{T} \vert y ∈ Y , f ∈ F , c ∈ C \} \qquad ( 2 )$$

where y=[pBESS,qBESS,vBESSsetpoint,qshunt]; pBESS,qBESS, are the active and reactive power absorption or injection demand request from the BESS, v_{BESSsetpoint} is voltage set point request to the BESS, qₛₕᵤₙₜ is the MVAR injection demand request from the nearby shunt compensating devices, f is the flow in the monitored facilities, and c is the charge stored in the battery pack.

With regard to action space, the action space A may be all the possible combinations of PBESS, q_{BESS}, VBESSsetpoint, qshunt.

With regard to reward, the objective of the inner loop may be to maintain the voltage and the flow of the monitored facilities within limits, minimizing the battery SOH degradation. Therefore, one may define the reward r that the agent receives after taking action a in state s as some polynomial combination of the line flow and the weighted battery SOH degradation. For the implementation of the inner reinforcement learning loop, the agent may be aware of the reward it receives after taking an action and in our case, the flow in the monitored facilities can be measured directly and the SOH degradation can be obtained indirectly through a SOH estimation routine in the BMS 118 and fed back to the CCS 130 through the ASSC 140.

With regard to the outer loop adaptive learning process, the flow in the monitored facilities together with the SOH degradation may be taken into account at each time step in the inner-loop of the disclosed reinforcement learning strategy. In the outer loop adaptive learning process, the learning agent may modulate the battery SOH degradation from a global point of view by tuning the range of battery SOC. This disclosed inner loop/outer loop process is merely for example purposes. Other implementations are contemplated.

With regard to state space, for the outer loop, one may define the state space using the system topology, such as estimated time of an N-1 or N-2 outage and how the battery SOC is related to this metric. A smaller SOC may be sufficient for supporting outage of less time duration whereas the SOC may need to be high for a sustained N-1 or N-2 outage. This state may also be derived from a supervised machine learning approach where the battery SOC is related to duration of the line outages required to support voltage and thermal flow in the monitored facilities.

With regard to action space, the action taken by the outer-loop agent may be to choose the optimum SOC range for a variety of system topologies as discussed above. Therefore, the output from the CCS 130 may include an optimum range of cₘₐₓ and cₘᵢₙ from this loop. As discussed above, the CCS 130 may send the optimum range to the EMS, which in turn may select one or more values from the optimal range in implementing the command as part of the local control tier.

Thus, the CCS 130 may automatically notify the BESS, through ASSC 140, any one, any combination, or all of pBESS, q_{BESS}, v_{BESS} for optimum voltage and thermal limits of the monitored facilities and in the process also minimizing the SOH degradation. The ASSC 140 may transfer this information to the EMS 120. In turn, the EMS 120 may automatically access the information of each cell from the BMS 118 and may automatically attempt to acknowledge the request of the CCS 130 by automatically optimizing the charge/discharge of individual strings and may automatically send this information to the PCS 114. The PCS 114, depending on the particular control mode (e.g., fixed power factor, Volt-VAR, Watt-VAR, Volt-Watt, Constant Reactive Power), may automatically set the inverter set points accordingly, with this information being fed back to the CCS 130.

FIG. 2B is an example block diagram 250 for the Energy Management System (EMS) 120. As discussed above, the EMS may automatically receive a command that originates from the CCS. For example, the one or more values for controllable variables generated by the CCS may be sent to the EMS. In turn, the EMS 120 may automatically generate one or more values for control. As discussed above, the EMS may be configured for granular control to automatically implement the values for the control variables that are input. For example, the EMS 120 may be more tailored to local control of the battery asset(s). As such, FIGS. 2A-B may be an example manifestation of the multi-tier control, with the CCS 130 comprising the global control tier and the EMS 120 comprising the local control tier.

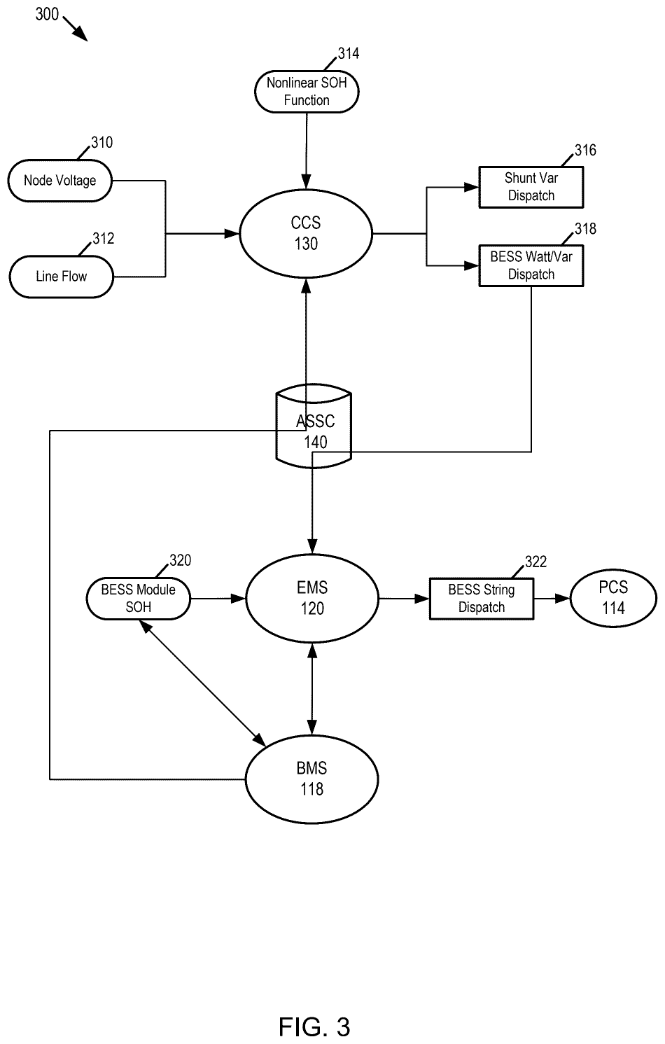

FIG. 3 is another example block diagram 300 for the system of intelligent BESS control for bulk power system monitoring and control. The CCS 130 may receive a variety of inputs as to the current state of the system, which may be based on sensor data and/or based on state data. This is illustrated, for example, in FIG. 3, in which the node voltage 310 and the line flow 312 are input to the CCS 130. Other data, such as state data (e.g., a state of shunt compensator(s)), may be input to the CCS 130. Other inputs as to the current state of the system are contemplated. The CCS 130 may also receive other types of input separate from the current state of the system, such as related to the functioning of the battery assets. For example, FIG. 3 illustrates that the CCS 130 may receive the nonlinear SOH function 314 associated with the battery assets. As discussed above, the SOH of the battery assets may follow a nonlinear function, which may complicate the interdependent control of the optimizing control of the grid and optimizing the SOH of the battery assets. Via the input of the nonlinear SOH function 314, the CCS 130 may account for the nonlinearity of the battery assets. As discussed further below, the CCS 130 may receive input from other sources, such as BMS 118.

Further, the CCS 130 may automatically generate one or more outputs in order to control the grid. In particular, in one or some embodiments, the control may relate to any one, any combination, or all of active power; reactive power; or apparent power, and may operate in any one, any combination, or all four quadrants including: Quadrant I (both powers flow positively in which there is an import of active power and reactive power); Quadrant II (reactive power flows positively and active power flows negatively); Quadrant III (both powers flow negatively in which both active power and reactive power are received); and Quadrant IV (reactive power flows negatively and active power flows positively). Mercly by way of example, control may comprise maintaining the load bus voltages within their permissible limits by reallocating reactive power generations in the system, which may be achieved in one or more ways, such as any one, any combination, or all of: adjusting transformer taps; adjusting generator voltages; adjusting switchable VAR sources; or redistributing reactive power in the system. Thus, in one or some embodiments, CCS 130 may generate one or more Var dispatch outputs, such as one or both of Shunt Var Dispatch 316 (e.g., the amount of dispatch for the shunt) and/or one or more aspects of the BESS setpoint (e.g., the power and/or voltage, such as BESS Watt/Var Dispatch 318).

The outputs from the CCS 130 may be automatically routed through the ASSC 140. For example, the BESS Watt/Var Dispatch 318 may be routed via the ASSC 140 to the EMS 120. In turn, the EMS 120 may calculate the optimal dispatch of each cell, sending the command to the PCS 114 to implement such. The PCS 114 may comprise the interface between the DC link of the battery assets and the AC busbar of the inverter. Once the PCS 114 receives the commanded output, the PCS 114 may set the inverters.

As such, the EMS 120 may be configured to automatically control and coordinate the BESS dispatch. The EMS 120 is configured to communicate directly with the PCS and BMS to provide high-level coordination of the various components on-site. In particular, after EMS 120 automatically calculates the optimal dispatch of each cell and thereby the modules making the BESS, the EMS 120 automatically sends this command, via the BESS String Dispatch 322, to the PCS 114. The PCS 114, acting as the interface between the DC link of the battery assets and the AC busbar of the inverter, responsive to receiving the command from the EMS 120, may automatically set the inverters.

In one or some embodiments, the EMS 120 is configured to automatically optimize the performance of the BESS by weighing long term cycling and capacity degradation with the return on investment of the asset. Alternatively, this function of optimizing long term performance may be moved to the CCS 130, such as described above with regard to the dual goals of the CCS 130 of optimizing control of the grid and optimizing battery SOH. Specifically, the CCS 130, with the reinforcement-learning based algorithm, may better optimize for long term performance of the battery assets. In turn, in one or some embodiments, the EMS 120 is configured to automatically fine tune the command issued by the CCS 130. In particular, the EMS 120 is configured to determine the optimal dispatch of individual cells (e.g., cells joined in series and parallel forms modules and many modules when joined together forms the entire BESS) to best honor the CCS command. As such, the CCS 130 and the EMS 120 may work in combination. In one or some embodiments, the command automatically issued by the CCS 130 may comprise a range of options, with the EMS 120, having more particular knowledge of the individual cells, selecting within the range of options issued by the CCS 130. Alternatively, the command automatically issued by the CCS 130 may comprise a single option, with the EMS 120, in implementing the single option may deviate within a predefined amount.

As shown in FIG. 3, the BMS 118 may automatically provide feedback, through the ASSC 140, to the CCS 130. In one or some embodiments, the BMS 118 is configured to protect part or all of the battery system. As such, the BMS 118 is configured to protect the battery from damage in a wide range of operating conditions. The BMS 118 may do so by ensuring that the battery cells operate within their prescribed operating windows for any one, any combination, or all of the state of charge; voltage; current; and temperature. In practice, the CCS 130 may issue a command. In turn, the EMS 120 may honor the command through the PCS 114. The BMS 118 may continue to monitor the BESS, such as via BESS Module SOH 320, to ensure compliance within acceptable parameters (e.g., not exceeding prescribed temperature limits). In the event that the BMS 118 identifies deviation from acceptable parameters, the BMS 118 may notify one or both of the CCS 130 and the EMS 120. Responsive thereto, one or both of the CCS 130 and the EMS 120 may modify control. In this regard, the BMS 118 may provide feedback to one or both of the EMS 120 or the CCS 130, with each modifying its operation accordingly. For example, the EMS 120 may modify the command to the PCS 114 via BESS String dispatch 332. As another example, the CCS 130, in optimizing the battery SOH, may seek the current state of the battery, which may include voltage and/or current of the battery, which may be provided by the BMS 118. Responsive to the input, the CCS 130 may modify its outputs, such as the BESS Watt/Var Dispatch 318 (e.g., the CCS 130 may calculate a different set point).

In practice, the CCS 130 may determine, based on the current grid condition, in which quadrant the BESS should operate (e.g., during a contingency scenario, the CCS 130 may determine that there is a need to prop up the voltage by changing the reactive power injection). However, modifying operation of the grid may have an effect on the battery SOH. As such, in practice, the CCS 130 may determine an optimal range of actions for controlling the grid. Within the optimal range of actions for controlling the grid, the CCS 130 may further determine a selected action that is optimal for battery state of health. Alternatively, or in addition, responsive to the CCS 130 determining one or more actions that is optimal for both the control of the grid and the battery asset(s) state of health and that results in a new state for the grid, the CCS 130 may determine the optimal transition to the new state for the grid. By way of example, the CCS 130 may initially command an injection of reactive power of 5% in order to boost the grid voltage. In turn, the grid voltage may be below nominal (e.g., where nominal is defined as 1 per unit). As such, the CCS 130 may command an increase in injection to approximately 20% with the CCS 130 determining the rate of transition from 5% to 20% based on the effect on the battery SOH and based on maintaining the grid voltage in an acceptable range (e.g., a grid voltage of 1.02 is selected, which is in an acceptable range of 1 per unit to 1.05 per unit).

Thus, the CCS 130 may make such considerations for active power injection or power absorption. For example, the CCS 130 may change the voltage setpoints of the BESS thereby modulating the active and reactive power absorption or injection based on the dual considerations of optimal control of the grid and optimal battery state of health. In one or some embodiments, the CCS 130 may actively monitor part or all of the grid, such as pre-defined lines, nearby shunt devices, etc. as a form of feedback to determine the responsive changes in the power flow in the lines and voltages in the substations. In turn, based on the monitoring of all of these assets, the CCS 130 may modify control of the grid (based on current state of the grid) to meet the dual goals of optimal control of the grid and optimal battery SOH.

FIG. 3 is an example of distributed intelligence, in which the CCS 130 determines the operation of part or all of the grid (e.g., input 100 MW into the grid) and in which the plurality of EMS (controlling different battery assets, such as different sets of batteries), responsive to the CCS 130 determination, determines the operation of a subpart of the grid (e.g., on the battery level, how the respective EMS determine to input, in total, the 100 MW into the grid, with the respective EMS considering the particularities of the respective sets of battery assets in the determination), it seems that there is decentralized intelligence. Your description says that the CCS will send information to the EMS, which acts as an intelligent EMS (e.g., optimizing performance by weighing longer term cycling and capacity degradation). So, it appears that the CCS does the big picture optimization while the EMS does the fine-tune optimization (trying to best honor the CCS command). In this regard, separate from the system being novel in terms of considering battery SOH (when implementing control), this particular decentralized implementation is particularly novel.

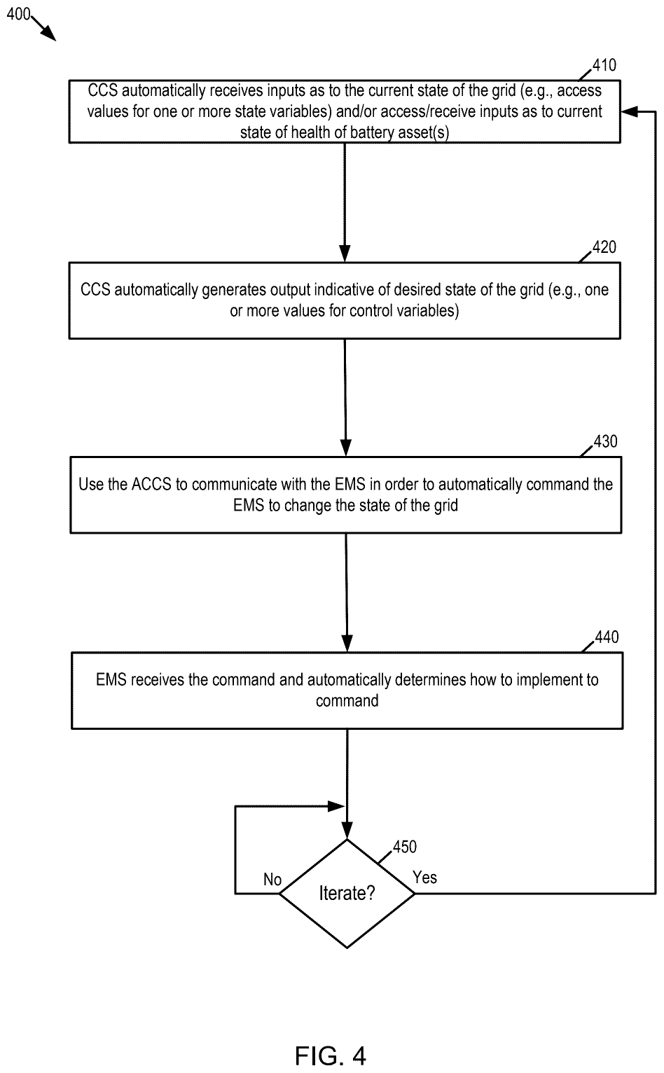

FIG. 4 is an example flow diagram 400 of the multi-tier control. At 410, the CCS receives inputs as to the current state of the grid (e.g., access values for one or more state variables) and/or access and/or receive inputs as to the current state of health of one or more battery assets. At 420, the CCS generates output indicative of desired state of the grid (e.g., one or more values for control variables). At 430, the ASSC is used to communicate with the EMS in order to command the EMS to change the state of the grid. At 440, the EMS receives the command and determines how to implement to command. At 450, the flow diagram 400 determines whether to iterate. If so, the flow diagram 400 moves back to 410. In one or some embodiments, the determination whether to iterate may be pre-set, and may be performed at pre-determined intervals. Alternatively, or in addition, the determination whether to iterate may be based on inputs to the CCS, such as a sensed change or a change of state in the system.

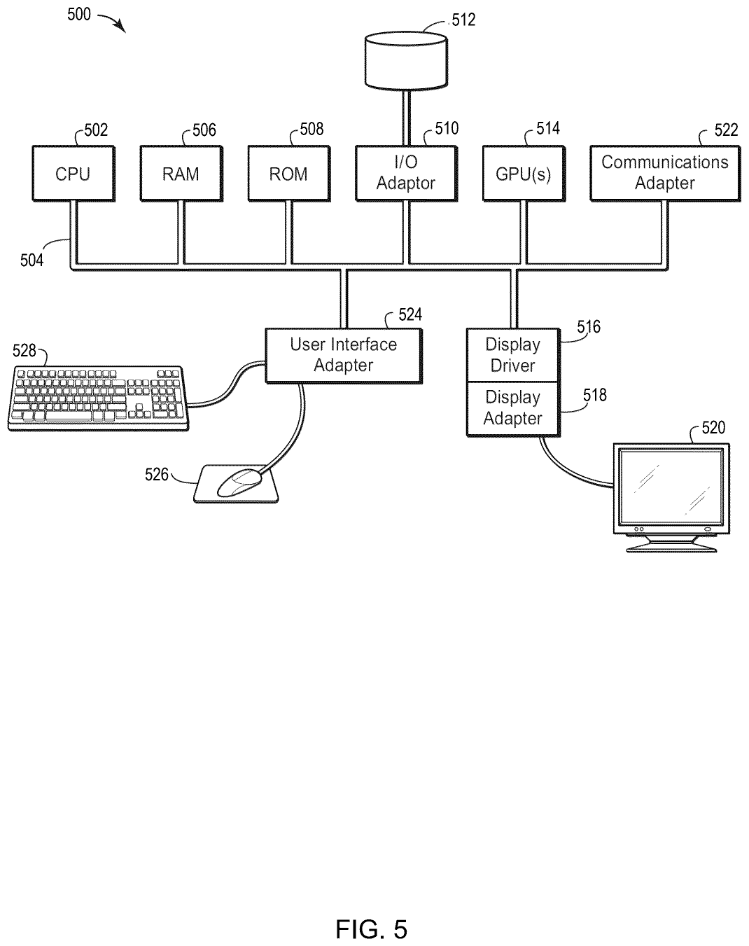

In all practical applications, the present technological advancement must be used in conjunction with a computer, programmed in accordance with the disclosures herein. Merely by way of example, various devices disclosed in the present application may comprise a computer or may work in combination with a computer (e.g., executed by a computer), such as, for example, in FIGS. 1A-C, 2A-B and 3. For example, computing functionality may be manifested in the electronics 112 of any one, any combination, or all of the PV unit 110, the PCS 114, the EMS 120, the CCS 130, or the ASSC 140. As such, computing functionality may be resident within any of the electronic devices discussed herein. Merely by way of example, FIG. 5 is a diagram of an exemplary computer system 500 that may be utilized to implement methods, including the flow diagrams, described herein. A central processing unit (CPU) 502 is coupled to system bus 504. The CPU 502 may be any general-purpose CPU, although other types of architectures of CPU 502 (or other components of exemplary computer system 500) may be used as long as CPU 502 (and other components of computer system 500) supports the operations as described herein. Those of ordinary skill in the art will appreciate that, while only a single CPU 502 is shown in FIG. 5, additional CPUs may be present. Moreover, the computer system 500 may comprise a networked, multi-processor computer system that may include a hybrid parallel CPU/GPU system. The CPU 502 may execute the various logical instructions according to various teachings disclosed herein. For example, the CPU 502 may execute machine-level instructions for performing processing according to the operational flow described herein.

The computer system 500 may also include computer components such as non-transitory, computer-readable media. Examples of computer-readable media include computer-readable non-transitory storage media, such as a random-access memory (RAM) 506, which may be SRAM, DRAM, SDRAM, or the like. The computer system 500 may also include additional non-transitory, computer-readable storage media such as a read-only memory (ROM) 508, which may be PROM, EPROM, EEPROM, or the like. RAM 506 and ROM 508 hold user and system data and programs, as is known in the art. In this regard, computer-readable media may comprise executable instructions to perform any one, any combination, or all of the blocks in the flow chart in FIG. 4. The computer system 500 may also include an input/output (I/O) adapter 510, a graphics processing unit (GPU) 514, a communications adapter 522, a user interface adapter 524, a display driver 516, and a display adapter 518.

The I/O adapter 510 may connect additional non-transitory, computer-readable media such as storage device(s) 512, including, for example, a hard drive, a compact disc (CD) drive, a floppy disk drive, a tape drive, and the like to computer system 500. The storage device(s) may be used when RAM 506 is insufficient for the memory requirements associated with storing data for operations of the present techniques. The data storage of the computer system 500 may be used for storing information and/or other data used or generated as disclosed herein. For example, storage device(s) 512 may be used to store configuration information or additional plug-ins in accordance with the present techniques. Further, user interface adapter 524 couples user input devices, such as a keyboard 528, a pointing device 526 and/or output devices to the computer system 500. The display adapter 518 is driven by the CPU 502 to control the display on a display device 520 to, for example, present information to the user such as images generated according to methods described herein.

The architecture of computer system 500 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 500 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting models discussed herein may be downloaded or saved to computer storage.

The following example embodiments of the invention are also disclosed:

### Embodiment 1

A power grid control system configured to control part or all of a power grid, the power grid control system comprising:
a communication interface configured to receive one or more indicators of status of the power grid and to send one or more commands indicative of control of the part or all of the power grid; and
at least one central control system (CCS) comprising in communication with the communication interface, the CCS configured to:
automatically access the one or more indicators of the status of the power grid;
automatically determine, using the one or more indicators of the status of the power grid, the one or more commands indicative of control of the part or all of the power grid, wherein the determination of the one or more commands is based on both controlling the part or all of the power grid to be within predefined parameters and to factor state of health (SOH) of one or more battery assets supplying power to or receiving power from the part or all of the power grid; and
automatically transmit the one or more commands in order to control the part or all of the power grid.

### Embodiment 2

The power grid control system of embodiment 1:
wherein the at least one processor is configured to automatically determine the one or more commands based on both controlling the part or all of the power grid to be within predefined parameters and to factor the SOH of the one or more batteries using reinforcement learning.

### Embodiment 3

The power grid control system of embodiments 1 or 2:
wherein the CCS is configured to automatically determine the one or more commands to control at least a first point of interconnection (POI) in the power grid and a second POI in the power grid;
wherein the CCS is configured to access the one or more indicators of the status of the first POI and the status of the second POI;
wherein at least a first battery asset is configured to service the first POI and at least a second battery asset is configured to service the second POI;
wherein the CCS is configured to:
   generate at least one command to control the at least first battery asset that services the first POI based on the one or more indicators of the status of the first POI and the SOH of the at least first battery asset; and
   generate at least one command to control the at least second battery asset that services the second POI based on the one or more indicators of the status of the second POI and the SOH of the at least second battery asset.

### Embodiment 4

The power grid control of any of embodiments 1-3:
wherein at least two battery assets service the first POI, each with a respective SOH;
wherein the CCS is configured to generate the at least one command to service the first POI to control the at least two battery assets differently based on the respective SOH of the at least two battery assets.

### Embodiment 5

The power grid control system of any of embodiments 1-4:
wherein the CCS is configured to automatically determine the one or more commands by interdependently performing both controlling the part or all of the power grid to be within predefined parameters and factoring the SOH of the one or more battery assets.

### Embodiment 6

The power grid control system of any of embodiments 1-5:
wherein the CCS is configured to determining the one or more commands in an interdependent manner by:
determining one or more potential values in order to control the part or all of the power grid to be within the predefined parameters; and
selecting, based on the one or more potential values, values for controlling the part or all of the power grid in order to optimize the SOH of the one or more battery assets.

### Embodiment 7

The power grid control system of any of embodiments 1-6:
wherein the CCS is configured to use a bi-level nested reinforcement learning framework that includes an inner loop configured to determine control of the part or all of the power grid to be within predefined standards and an outer loop to optimize the battery SOH.

### Embodiment 8

The power grid control system of any of embodiments 1-7:
further comprising one or more energy management systems (EMS) configured to control respective battery assets;
wherein the CCS is configured to generate the one or more commands for receipt by the one or more EMS; and
wherein the one or more EMS are configured to implement the one or more commands generated by the CCS in order to control the respective battery assets.

### Embodiment 9

The power grid control system of any of embodiments 1-8:
wherein the one or more EMS comprise a plurality of EMS, each of the plurality of EMS configured to control respective one or more battery assets for the grid;
wherein the one or more commands comprises one or more values for controlling the battery assets;
wherein, responsive to receipt of the one or more commands, the one or more EMS are configured to:
   determine whether to modify the one or more values in the one or more commands; and
   responsive to determining to modifying the one or more values, control the battery assets based on the modified one or more values.

### Embodiment 10

The power grid control system of any of embodiments 1-9:
wherein the CCS is configured to control the battery assets in order to optimize the SOH for the battery assets that are controlled by the plurality of EMS; and
wherein each of the plurality of EMS are configured to perform only local control of its respective assigned battery assets.

### Embodiment 11

The power grid control system of any of embodiments 1-10:
further comprising a plurality of battery management systems (BMS) assigned to respective ones of the EMS; and
wherein a respective BMS is configured to monitor operation of respective battery assets and to provide feedback to both of the CCS and to a respective EMS.

### Embodiment 12

The power grid control system of any of embodiments 1-11:
further comprising a Supervisory System Controller (SSC) configured to route information flow between the CCS, the plurality of BMS, the plurality of the EMS, and a plurality of power conversion systems.

### Embodiment 13

The power grid control system of any of embodiments 1-12:
wherein, responsive to failure of one or more of the EMS, the SSC is configured to control the respective one or more battery assets for the grid.

### Embodiment 14

The power grid control system of any of embodiments 1-13:
wherein the CCS is configured to generate the one or more commands for the plurality of EMS in order to perform system-wide control and to factor the SOH of the one or more battery assets controlled by the plurality of EMS; and
wherein, the EMS, responsive to receipt of the one or more commands, are configured to perform local control of respective battery assets under control of a respective EMS.

### Embodiment 15

The power grid control system of any of embodiments 1-14:
wherein the respective EMS is configured to modify the one or more commands received from the CCS as part of the system-wide control based on specific knowledge of the respective battery assets under the control of the respective EMS.

### Embodiment 16

The power grid control system of any of embodiments 1-15:
wherein the CCS is configured to receive the modifications of the one or more commands by the respective EMS in order for the CCS to modify generation of future commands to the respective EMS to reduce or eliminate the modifications performed by the respective EMS.

### Embodiment 17

The power grid control system of any of embodiments 1-16:
wherein the CCS and the respective EMS are both physically decoupled from one another being located in different physical locations and functionally decoupled from one another by the CCS performing the system-wide control for the battery assets across the plurality of EMS and the respective EMS performing the local control of its respective battery assets.

### Embodiment 18

The power grid control system of any of embodiments 1-17:
wherein the one or more energy management systems comprises a first EMS configured to control a respective battery asset comprising a plurality of cells;
wherein the first EMS is configured to receive at least one command from the CCS, the command indicative of controlling the respective battery asset;
wherein the first EMS is configured to determine the SOH of one or more of the plurality of cells; and
wherein the first EMS is configured to control different cells within the plurality of cells differently based on the SOH of the one or more of the plurality of cells while still executing the at least one command from the CCS.

### Embodiment 19

The power grid control system of any of embodiments 1-18:
wherein the CCS is further configured to access priority indicative of whether the CCS is configured to factor SOH of the one or more battery assets over generating a desired response in controlling the grid; and
wherein the CCS is configured to generate the one or more commands based on the accessed priority.

### Embodiment 20

The power grid control system of any of embodiments 1-19:
wherein the CCS is configured to generate the one or more commands by:
determining a range of operation in which to control the part or all of the power grid to be within the predefined parameters; and
selecting, based on analyzing the battery SOH, one or more values within the range of operation; and
generating the one or more commands based on the one or more values.

### Embodiment 21

The power grid control system of any of embodiments 1-20:
wherein the part or all of the power grid comprises at least one operating parameter; and
wherein the CCS is configured to generate the one or more commands by:
   determining the range of values for the at least one operating parameter in which to control the part or all of the power grid to be within the predefined parameters; and
   selecting, based on analyzing the battery SOH, a desired value of the at least one operating parameter within the range of values; and
   generating, based on the desired value of the at least one operating parameter, the one or more commands in order to control the part or all of the power grid.

### Embodiment 22

The power grid control system of any of embodiments 1-21:
wherein the part or all of the power grid is operated at a current value of the at least one operating parameter;
wherein the CCS is configured to generate the one or more commands by determining, based on analyzing the battery SOH, a rate of transition from the current value of the at least one operating parameter to the desired value of the at least one operating parameter; and
wherein the CCS is configured to control the part or all of the power grid at the rate of transition from the current value of the at least one operating parameter to the desired value of the at least one operating parameter.

### Embodiment 23

A computer-implemented method of performing the functions in any combination or order as described in any of embodiments 1-22.

### Embodiment 24

A system comprising:
a processor; and
a non-transitory machine-readable medium comprising instructions that, when executed by the processor, cause a computing system to perform a method according to any of embodiments 1-22.

### Embodiment 25

A non-transitory machine-readable medium comprising instructions that, when executed by a processor, cause a computing system to perform a method according to any of embodiments 22.

What is claimed is:

1. A power grid control system configured to control part or all of a power grid, the power grid control system comprising:
a communication interface configured to receive one or more indicators of status of the power grid and to send one or more commands indicative of control of the part or all of the power grid; and
at least one central control system (CCS) comprising in communication with the communication interface, the CCS configured to:
automatically access the one or more indicators of the status of the power grid;
automatically determine, using the one or more indicators of the status of the power grid, the one or more commands indicative of control of the part or all of the power grid, wherein the determination of the one or more commands is based on both controlling the part or all of the power grid to be within predefined parameters and to factor state of health (SOH) of one or more battery assets supplying power to or receiving power from the part or all of the power grid; and
automatically transmit the one or more commands in order to control the part or all of the power grid.

2. The power grid control system of claim 1, wherein the CCS is configured to automatically determine the one or more commands based on both controlling the part or all of the power grid to be within predefined parameters and to factor the SOH of the one or more battery assets using reinforcement learning.

3. The power grid control system of claim 1, wherein the CCS is configured to automatically determine the one or more commands to control at least a first point of interconnection (POI) in the power grid and a second POI in the power grid;
wherein the CCS is configured to access the one or more indicators of the status of the first POI and the status of the second POI;
wherein at least a first battery asset is configured to service the first POI and at least a second battery asset is configured to service the second POI;
wherein the CCS is configured to:
generate at least one command to control the at least first battery asset that services the first POI based on the one or more indicators of the status of the first POI and the SOH of the at least first battery asset; and
generate at least one command to control the at least second battery asset that services the second POI based on the one or more indicators of the status of the second POI and the SOH of the at least second battery asset.

4. The power grid control system of claim 3, wherein at least two battery assets service the first POI, each with a respective SOH;
wherein the CCS is configured to generate the at least one command to service the first POI to control the at least two battery assets differently based on the respective SOH of the at least two battery assets.

5. The power grid control system of claim 1, wherein the CCS is configured to automatically determine the one or more commands by interdependently performing both controlling the part or all of the power grid to be within predefined parameters and factoring the SOH of the one or more battery assets.

6. The power grid control system of claim 5, wherein the CCS is configured to determining the one or more commands in an interdependent manner by:
determining one or more potential values in order to control the part or all of the power grid to be within the predefined parameters; and
selecting, based on the one or more potential values, values for controlling the part or all of the power grid in order to optimize the SOH of the one or more battery assets.

7. The power grid control system of claim 6, wherein the CCS is configured to use a bi-level nested reinforcement learning framework that includes an inner loop configured to determine control of the part or all of the power grid to be within predefined standards and an outer loop to optimize the battery SOH.

8. The power grid control system of claim 1, further comprising one or more energy management systems (EMS) configured to control respective battery assets;
wherein the CCS is configured to generate the one or more commands for receipt by the one or more EMS; and
wherein the one or more EMS are configured to implement the one or more commands generated by the CCS in order to control the respective battery assets.

9. The power grid control system of claim 8, wherein the one or more EMS comprise a plurality of EMS, each of the plurality of EMS configured to control respective one or more battery assets for the grid;
wherein the one or more commands comprises one or more values for controlling the battery assets;
wherein, responsive to receipt of the one or more commands, the one or more EMS are configured to:
determine whether to modify the one or more values in the one or more commands; and
responsive to determining to modifying the one or more values, control the battery assets based on the modified one or more values.

10. The power grid control system of claim 9, wherein the CCS is configured to control the battery assets in order to optimize the SOH for the battery assets that are controlled by the plurality of EMS; and
wherein each of the plurality of EMS are configured to perform only local control of its respective assigned battery assets.

11. The power grid control system of claim 10, further comprising a plurality of battery management systems (BMS) assigned to respective ones of the EMS; and
wherein a respective BMS is configured to monitor operation of respective battery assets and to provide feedback to both of the CCS and to a respective EMS.

12. The power grid control system of claim 11, further comprising a Supervisory System Controller (SSC) configured to route information flow between the CCS, the plurality of BMS, the plurality of the EMS, and a plurality of power conversion systems.

13. The power grid control system of claim 12, wherein, responsive to failure of one or more of the EMS, the SSC is configured to control the respective one or more battery assets for the grid.

14. The power grid control system of claim 9, wherein the CCS is configured to generate the one or more commands for the plurality of EMS in order to perform system-wide control and to factor the SOH of the one or more battery assets controlled by the plurality of EMS; and
wherein, the EMS, responsive to receipt of the one or more commands, are configured to perform local control of respective battery assets under control of a respective EMS.

15. The power grid control system of claim 14, wherein the respective EMS is configured to modify the one or more commands received from the CCS as part of the system-wide control based on specific knowledge of the respective battery assets under the control of the respective EMS.

16. The power grid control system of claim 15, wherein the CCS is configured to receive the modifications of the one or more commands by the respective EMS in order for the CCS to modify generation of future commands to the respective EMS to reduce or eliminate the modifications performed by the respective EMS.

17. The power grid control system of claim 15, wherein the CCS and the respective EMS are both physically decoupled from one another being located in different physical locations and functionally decoupled from one another by the CCS performing the system-wide control for the battery assets across the plurality of EMS and the respective EMS performing the local control of its respective battery assets.

18. The power grid control system of claim 8, wherein the one or more energy management systems comprises a first EMS configured to control a respective battery asset comprising a plurality of cells;
wherein the first EMS is configured to receive at least one command from the CCS, the command indicative of controlling the respective battery asset;
wherein the first EMS is configured to determine the SOH of one or more of the plurality of cells; and
wherein the first EMS is configured to control different cells within the plurality of cells differently based on the SOH of the one or more of the plurality of cells while still executing the at least one command from the CCS.

19. The power grid control system of claim 1, wherein the CCS is further configured to access priority indicative of whether the CCS is configured to factor SOH of the one or more battery assets over generating a desired response in controlling the grid; and
wherein the CCS is configured to generate the one or more commands based on the accessed priority.

20. The power grid control system of claim 1, wherein the CCS is configured to generate the one or more commands by:
determining a range of operation in which to control the part or all of the power grid to be within the predefined parameters; and
selecting, based on analyzing the battery SOH, one or more values within the range of operation; and
generating the one or more commands based on the one or more values.

21. The power grid control system of claim 20, wherein the part or all of the power grid comprises at least one operating parameter; and
wherein the CCS is configured to generate the one or more commands by:
determining the range of values for the at least one operating parameter in which to control the part or all of the power grid to be within the predefined parameters; and
selecting, based on analyzing the battery SOH, a desired value of the at least one operating parameter within the range of values; and
generating, based on the desired value of the at least one operating parameter, the one or more commands in order to control the part or all of the power grid.

22. The power grid control system of claim 21, wherein the part or all of the power grid is operated at a current value of the at least one operating parameter;
wherein the CCS is configured to generate the one or more commands by determining, based on analyzing the battery SOH, a rate of transition from the current value of the at least one operating parameter to the desired value of the at least one operating parameter; and
wherein the CCS is configured to control the part or all of the power grid at the rate of transition from the current value of the at least one operating parameter to the desired value of the at least one operating parameter.
